(19) United States
(12) Patent Application Publication
(10) Pub. No.: US 2020/0310367 A1
(43) Pub. Date: Oct. 1, 2020

(54) ROBOTIC ENTERTAINMENT BOOTH

(71) Applicant: Realbotix, LLC, San Marcos, CA (US)

(72) Inventor: Matthew McMullen, San Marcos, CA (US)

(21) Appl. No.: 16/834,978

(22) Filed: Mar. 30, 2020

Related U.S. Application Data
(60) Provisional application No. 62/826,150, filed on Mar. 29, 2019.

(51) Int. Cl. G05B 13/02; G06Q 20/18; G06N 3/00; G06N 20/00; B25J 11/00; G10L 15/22; G06F 3/16

(52) U.S. Cl. CPC G05B 13/0265; G06Q 20/18; G06N 3/008; G10L 2015/223; B25J 11/0005; G10L 15/22; G06F 3/167; G06N 20/00

(57) ABSTRACT

Systems and apparatus are disclosed herein of an entertainment both for providing robotic entertainment. For example, a robotic entertainment system is provided that includes a booth having a housing enclosing a viewing station opposite an entertainment station; a robotic entertainer disposed within the entertainment station, the robotic entertainer having a humanoid appearance and comprising a plurality of actuators; and a computing system coupled to the plurality of actuators and configured to control the actuators so to move the robotic entertainer in accordance with a performance.

### CROSS-REFERENCES TO RELATED APPLICATIONS

This application claims the benefit of U.S. provisional patent application Ser. No. 62/826,150, filed Mar. 29, 2019 and entitled “ROBOTIC GOGO DANCER BOOTH,” the disclosure of which is hereby incorporated by reference in its entirety.

### TECHNICAL FIELD

This disclosure relates to robots. More specifically, this disclosure relates to a booth for robotic entertainment.

### BACKGROUND

Entertainment consumption is regularly increasing in sophistication. In many of today's entertainment options it is desired to immerse the player in a particular environment, for example, through the use of large video screens and surround sounds systems; augmented reality systems; and virtual reality systems that present graphically rendered entertainment consumed through visual and audio senses of the patron.

One way to immerse a player has been to provide a hugely stimulating experience which heavily loads the players' sensory inputs with audio and visual effects and overwhelms distractions output from speakers and generated on displays. Some implementations provide a booth or other enclosure with a display to provide a secluded area to consume the visually generated entertainment. While these booths do achieve some degree of immersion, they are restricted to the two dimensional and graphically generated or pre-recorded entertainment media, such as videos or movies.

It is an object of this disclosure to provide an improved booth or enclosure which for consuming immersive entertainment.

### SUMMARY

Systems and apparatus are disclosed herein of an entertainment both for providing robotic entertainment. In one aspect, a robotic entertainment system is disclosed that includes a booth having a housing enclosing a viewing station opposite an entertainment station and a robotic entertainer disposed within the entertainment station. The robotic entertainer may have a humanoid appearance and comprises a plurality of actuators. The robotic entertainment system also includes a computing system coupled to the plurality of actuators and configured to control the actuators so to move the robotic entertainer in accordance with a performance.

In another aspect, an entertainment booth is disclosed. The entertainment booth comprises a housing divided into a viewing area and an entertainment area. The viewing area is arranged to receive a user for viewing the entertainment area. A robotic entertainer having a plurality of actuators is disposed within the entertainment area. The entertainment booth also includes a processing system coupled to the plurality of actuators and configured to control the actuators so to move the robotic entertainer in accordance with a collection of movements.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a graphical representation of an embodiment of a robotic entertainment booth according to various embodiments.

FIG. 2 is graphical representation of another view of the robotic entertainment booth FIG. 1.

FIG. 3 is a cutaway view of the of the robotic entertainment booth of FIG. 1.

FIG. 4 is a functional block diagram of the robotic entertainment system that can be implemented with the robotic entertainment booth of FIG. 1.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent that those skilled in the art will be able to understand the disclosure without these specific details. In some instances, well-known structures and components are shown in simplified form for brevity of description. Some of the surfaces have been left out or exaggerated for clarity and ease of explanation.

Embodiments herein provide a robotic entertainment booth where paying customers can cycle through a series movements performed by a robotic entertainer within the robotic entertainment booth, and the longer they stay inside the more they will get to see. In addition a chatbot system can be integrated so that users can talk to the robot during entertainment. This system can also be run via remote control with a human operator for chat and interaction. The series or collection of movements may be defined by a performance or entertainment program. There can be non-adult versions as well offering a variety of interactive services such as advice, psychic readings, etc. The robotic characters within the booth can be very diverse, from sexy dancers to fantasy creatures, to robotic guides. Interactions and lure to pay can be equally diverse.

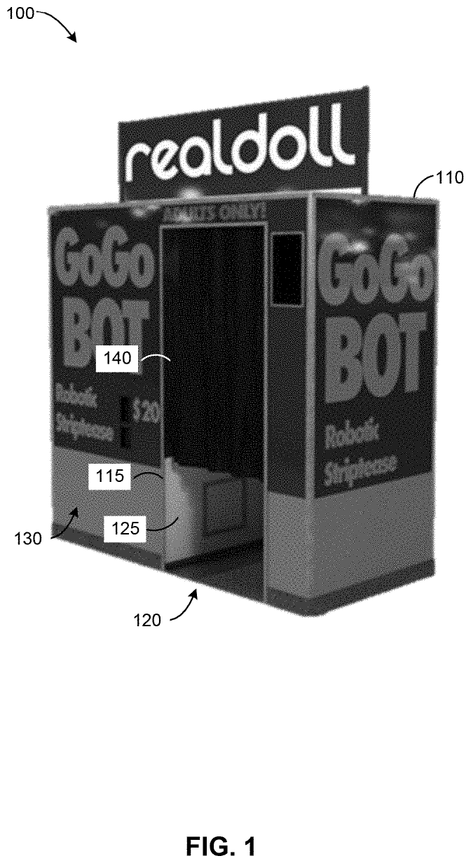

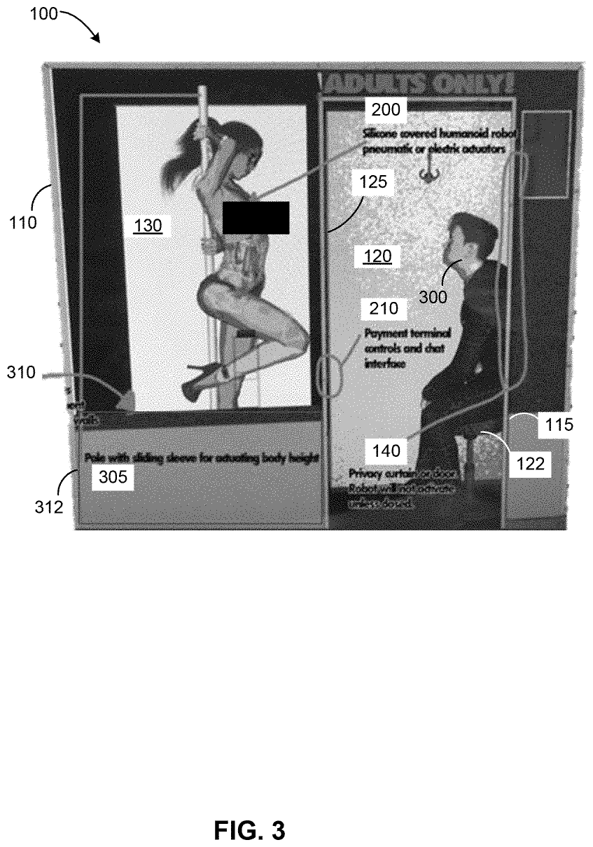

FIG. 1 is a graphical representation of an embodiment of a robotic entertainment booth 100. The robotic entertainment booth can have an outer housing 110 that encloses a viewing station 120 (e.g., including a seat as described below) and a robotic entertainment station 130 housing a robotic entertainer. The outer housing can be a self-contained booth with a robotic entertainer inside. The housing 110 can have an opening 115 through which the patron can enter. The viewing station 120 can include a seat on which the patron can sit (e.g., as shown in FIG. 3). In addition, the robotic entertainment station 130 can be separated from the viewing station 120 by, for example, a divider 125 (a portion of which is illustrated in FIG. 1). The divider 125 may include a transparent or partially transparent portion or the entire divider may be transparent or partially transparent (e.g., a percentage of transparency or opacity). In some implementations, divider 125 may not be present, allowing increased direct interaction between the patron and the robotic entertainer. The booth or outer housing can include a privacy door or curtain 140. The privacy door or curtain can be actuated or enabled following payment by patron, for example.

The robotic entertainment booth shown in FIG. 1 is depicted as an adults-only robotic striptease booth. However, the disclosure is not so limited. The robotic entertainment booth can further include other non-adult material. For example, the robotic entertainer may include one or more robotic entertainer(s) and elements for acting out scenes (e.g. from a film or video using robots) and/or may be controlled, for example, by the patron to provide for an arcade game experience.

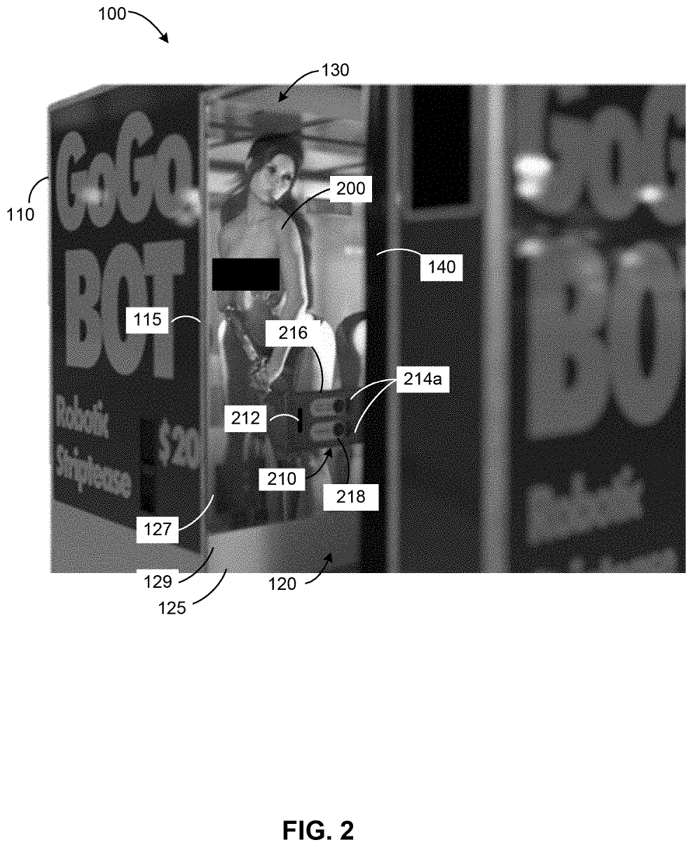

FIG. 2 is a graphical representation of another view of the robotic entertainment booth 100 of FIG. 1. As shown in FIG. 2, the opening 115 is provided through which the patron may access the viewing station 120 opposite the robotic entertainer 200 disposed within the robotic entertainment station 130, with optional divider 125 therebtween. The divider 125 may have a planar shape that extends vertically from the base or floor of the booth 100 such that the divider is substantially perpendicular with respect to a viewing direction of the user (as shown in FIG. 3). Divider 125 may include a transparent or partially transparent portion 127 and opaque portion 129. In some embodiments, the divider 125 may include only the transparent or partially transparent portion 127, for example, the transparent portion 127 is the entire divider 125. The transparent portion 127 may have a percentage of transparency between 100% transparent and 0% transparent based on the desired transparency of the application. In some embodiments, the transparency may be electrically controller (e.g., smart or switchable glass) in response to a patron selecting a form of entertainment.

Robotic entertainment booth can include a user interface system 210 including built-in payment systems including, a credit card reader 212 (e.g., slot, chip, or NFC credit card reader) or other payment means 214 for receiving payment such as paper currency, coins, or tokens. Paying customers can cycle through a series of dances or other animations. The entertainment can feature adult-only material such as a striptease, for example. Non-adult versions are also included, such as, a variety of interactive services such as advice, psychic readings, etc. Selection of the entertainment may be through user interfaces 216 and 218, for example, inputs 216 and 218 may correspond to different entertainment types, different dances, different scenes, etc.

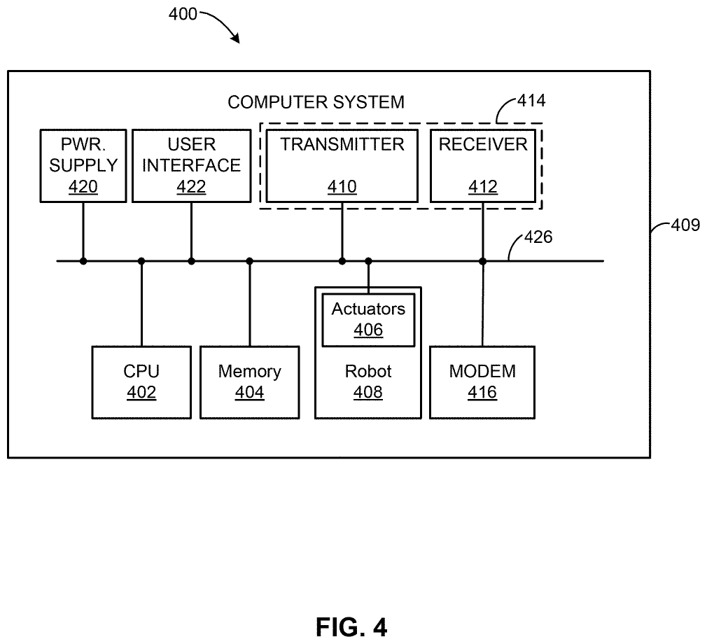

The robotic entertainment within the outer housing 110 can be a robot 200, with or without artificial intelligence. Patrons can interact with the robotic entertainment verbally or by way of a user interface 216 and/or 218 within the housing, for example. For example, one of user interface 216 and/or 218 may provide for chat interface controls (e.g., a chatbot system whereby users can talk to the robot during entertainment). The other user interface may provide for tactile control of the robotic entertainment booth. The chat interface controls may include a microphone for receiving verbal command inputs from the patron and speech recognition software (e.g., stored in memory 404 of FIG. 4) configured to receive and interrupt the verbal commands from the patron. The chat interface may also include one or more speakers for providing audio output in response to the verbal inputs from the user and/or as part of the entertainment.

The robotic entertainment herein is a robotic dancer as a primary example, however the associated robot need not be limited to a dancer. The robotic entertainment itself can include a diverse variety of robotic characters from sexy entertainments to fantasy creatures and robotic guides. Interactions with the robot and lure to pay for additional interaction can be equally diverse. The robotic entertainment can be a humanoid or humanlike “GoGoBot.”

FIG. 3 is a cutaway view of the embodiments of the robotic entertainment booth 100 of FIG. 1 and FIG. 2. The robotic entertainer 200 can move (e.g., dance) or otherwise interact with user or patron 300. The patron 300 may be able to view the robotic entertainer 200 from viewing station 120, and may be situated on seat 122 therein. The longer they interact, the more the patron can experience or see. A wide variety of characters can be installed in various booths, each with distinct personalities and interactions. In some examples there can be explicit adult versions of the robot with actual sex acts within (e.g., sex toy and a robot, two or more robots, male and female robot, etc.).

The housing 110 can include a robotic entertainment system 310 within a system housing 312 that contains various power and robotics peripheral equipment hidden within the floor and walls of the housing booth. For example, the power and robotics peripheral equipment may be implemented as the robotic entertainment system 400 of FIG. 4.

The user interface system 210 may include a payment terminal, controls, chat interface, and/or other user interface features can be included in the housing or booth as described above in connection to FIG. 2. Such user interface features can be mounted or otherwise positioned in front of the patron and viewing area. In some implementations the user interface can be coupled to a transparent divider 125 disposed between the robotic entertainer 200 and patron 300. Some implementations may not have any divider between the robot(s) and the patron.

As shown in FIG. 3, the robotic entertainer 200 can be a humanoid robot attached to a pole 305. Humanoid robot can have pneumatic or electrical actuators as described below. In various embodiments, the humanoid robot may comprise a covering or artificial skin arranged to provide a humanoid appearance. The artificial skin may be made of any desired material, for example, silicon or other materials to provide a human skin like appearance and texture. The pole 305 may include a sliding sleeve for actuating a position of the robotic entertainer 200 along the pole 305. For example, the robotic entertainer 200 may be actuated in a vertical position along the pole 305.

While embodiments herein describe the robotic entertainer as a humanoid robot, it will be appreciated that the robotic entertainer 200 may be designed to have any form based on the desired form of entertainment. Furthermore, while a single robotic entertainer 200 is illustrated in the embodiments herein, the booth 100 may comprise any number of robotic entertainers disposed with the robotic entertainment region 130.

FIG. 4 is a functional block diagram of the robotic entertainment system 400 (also referred to herein as a processing system or computing system) that can be implemented with the robotic entertainment booth 100 of FIG. 1, FIG. 2, and FIG. 3. A robotic entertainment system (system) 400 can include the robotic entertainment booth 100 as disclosed herein, for example, as robotic entertainment system 310 of FIG. 3. The system 400 can also include other implementations including, but not limited to, non-adult entertainment systems, robotic fortunetellers, or robotic entertainers (e.g., go-go dancers or the like) as shown in the preceding images.

The system 400 can include one or more processor units (processor) 402. The processor 402 can controls operation of the system 400. The processor 402 can also be referred to as a central processing unit (CPU). The processor 402 can include multiple processors or microprocessors as needed. Processor 402 can perform all the functions required to allow the robotic entertainment to perform according to programmable instructions, user interaction, and payment from the patron, for example. The processor 402 can include or be a component of a processing system implemented with one or more processors 402. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The system 400 can also have a memory 404 coupled to the processor 402. The memory 404 can include both read-only memory (ROM) and random access memory (RAM). The memory 404 can provide instructions and data to the processor 402. At least a portion of the memory 404 can also include non-volatile random access memory (NVRAM). The processor 402 can perform logical and arithmetic operations based on program instructions stored within the memory 404. The instructions in the memory 404 can be executable to implement the behaviors and motion of the robotic entertainment. In some implementations, the memory 404 can store multiple performance programs, for example, multiple personalities for a given robotic entity within the booth, multiple collections of movements, etc. In some examples, the patron can select from among one or more personalities or interactions with the robotic entertainment. Such personalities can be based on artificial intelligence, preprogrammed interactions, and/or machine learning. Such personalities can also learn characteristics, behaviors, or desires of repeat customers, for example. For example, patron may create a profile stored with in the memory 404 comprising historical data of the customers selections input via the user interface and preferences based on a questionnaire prompts, and at least one of the multiple personalities may be based on the learned selections and responses.

The processing system and the memory 404 can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The system 400 can have a plurality of actuators 406 that can control the robotic entertainment (robot) 408. The actuators 406 can be communicatively coupled to the processor 402. The processor 402 can execute instructions contained in the memory 404 to command movement of one or more of the plurality of actuators 406 to perform various behaviors or movements of the robot 408. The plurality of actuators 406 can manipulate or move extremities of the robot 408 such as legs, arms, fingers, and head, but also facial movements associated with, for example, eyelids, mouth, and facial expressions. The actuators 406 can be electrical, electro-mechanical, pneumatic, hydraulic, etc. to accomplish movement of the movable elements of the robot in the booth/housing. The actuators 406 can also include manipulate the position of the robotic entertainer along pole 305, for example, actuators 406 may include a sleeve as described above in connection to FIG. 3.

The system 400 can also include a transmitter 410 and/or a receiver 412 to allow transmission and reception of data between the system 400 and a remote location. The transmitter 410 and the receiver 412 can be combined into a transceiver 410. The system 400 can also include (not shown) multiple transmitters, multiple receivers, multiple transceivers, and/or multiple antennas as needed for various communication standards via wireless or wireline communications. The system 400 can further have a modem 416 coupled to the transmitter 410, the receiver 412, or the transceiver 414. The modem 416 can perform modulation demodulation tasks for communication with an external network, for example. In some implementations the processor 402 can communicate via the transmitter 410, the receiver 412, and/or the transceiver 414 via the Internet, as needed to provide a lifelike performance by the robotic entertainment. In some embodiments, the transmitter 210 and the receiver 212 can be configured to transmit and receive information via other wired or wireline systems or means.

The system 400 can have a user interface 422. The user interface 422 can include one or more controls allowing user interaction by the patron. For example user interface 422 can include one or more buttons, keys, pointing device, speakers, and/or microphones to provide means for interaction with the robotic entertainment. A user can interact with the user interface 422 to select, for example, desired behaviors of the robotic entertainment or other character. The user interface 422 can further include a payment terminal, kiosk, or other system used to take payments from a patron. For example, user interface system 210 may be implemented as user interface 422.

The system 400 can further have a power supply 420. The power supply 420 can provide power to the system either via power backbone (e.g., AC power) or via battery.

The various components of the system 400 can be coupled together by a bus system 426. The bus system 426 can include a data bus, for example, as well as a power bus, a control signal bus, and a status signal bus in addition to the data bus. The components of the system 400 can be coupled together or accept or provide inputs to each other using some other mechanism.

The various components of the system 400 can be enclosed by a housing 409. The housing 409 can be an outer enclosure forming the booth (e.g., housing 110), having one or more openings for entry and exit of the patron, and compartments for housing electronics and the robot 408. The housing 409 can further have one or more openings for entry and exit ways such as a door or curtain. The entry and exit way(s) can further have a motorized/automatic entry and exit ways controlled by the processor 402, for example. In some implementations, the entry and exit ways can be manually operated. In another example, housing 409 may be system housing 312, as described above in connection to FIG. 3, housed within the housing 110.

Although a number of separate components are illustrated in FIG. 4, one or more of the components can be combined or commonly implemented.

Reference throughout this specification to one/an “implementation”, “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The hardware used to implement the various illustrative logics, logical blocks, and modules described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Thus, the claims are not intended to be limited to the aspects shown herein, but is to be accorded the full scope consistent with the language claims, wherein reference to an element in the singular is not intended to mean “one and only one” unless specifically so stated, but rather “one or more.”

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A robotic entertainment system comprising:
a booth having a viewing station opposite an entertainment station and a housing enclosing the viewing station and the entertainment station;
a robotic entertainer disposed within the entertainment station, the robotic entertainer having a humanoid appearance and comprising a plurality of actuators; and
a computing system coupled to the plurality of actuators and configured to control the actuators so to move the robotic entertainer in accordance with a performance.

2. The robotic entertainment system of claim 1, further comprising a divider positioned between the viewing station and the entertainment station, the divider extending in a planar direction perpendicular to a viewing direction.

3. The robotic entertainment system of claim 2, wherein the divider is transparent.

4. The robotic entertainment system of claim 1, further comprising a user interface comprising one or more controls for user interaction by a patron.

5. The robotic entertainment system of claim 4, wherein the user interface system further comprises a payment terminal for receiving payment from a patron.

6. The robotic entertainment system of claim 4, wherein the user interface system further comprises verbal interface configured to received verbal command inputs from patron, wherein the computing system is configured to control the robotic entertainer based on the verbal command inputs.

7. The robotic entertainment system of claim 1, wherein the computing system comprises:
at least one memory storing instructions for controlling the robotic entertainer; and
at least one processor configured to execute the instructions stored in the at least one memory to control the robotic entertainer.

8. The robotic entertainment system of claim 7, wherein the instructions comprise a plurality of performance programs, and wherein the at least one processor is configured to execute one of the plurality performance programs in response to selection by a patron.

9. The robotic entertainment system of claim 8, wherein at least one of the performance programs comprises one of artificial intelligence and machine learning.

10. The robotic entertainment system of claim 8, wherein at least one of the performance programs is based, in part, on historical data corresponding to a single patron.

11. The robotic entertainment system of claim 1, wherein the robotic entertainer is coupled to a pole via a sliding sleeve configured to actuate a position of the entertainer along the pole.

12. The robotic entertainment system of claim 1, wherein the robotic entertainer comprises a plurality of extremities, wherein the actuators are configured to manipulate each of the plurality of extremities.

13. The robotic entertainment system of claim 1, wherein the plurality of actuators comprises one or more of an electrical actuator, electro-mechanical actuator, pneumatic actuator, and hydraulic actuator.

14. An entertainment booth comprising:
a housing divided into a viewing area and an entertainment area, wherein the viewing area is arranged to receive a user for viewing the entertainment area;
a robotic entertainer having a plurality of actuators disposed within the entertainment area; and
a processing system coupled to the plurality of actuators and configured to control the actuators so to move the robotic entertainer in accordance with a collection of movements.

15. The entertainment booth of claim 14, further comprising a divider positioned between the viewing area and the entertainment area, the divider extending in a planar direction perpendicular to a viewing direction.

16. The entertainment booth of claim 14, further comprising a user interface comprising one or more controls for user interaction by a patron.

17. The entertainment booth of claim 14, wherein the robotic entertainment system is configured to execute one of a plurality performance programs in response to selection by the patron, wherein each of the plurality of performances comprises a collection of movements.

18. The entertainment booth of claim 1, wherein the robotic entertainer is coupled to a pole via a sliding sleeve configured to actuate a position of the entertainer alone the pole.

19. The entertainment booth of claim 1, wherein the robotic entertainer comprises a plurality of extremities, wherein the actuators are configured to manipulate each of the plurality of extremities.

20. The entertainment booth of claim 1, wherein the plurality of actuators comprises one or more of an electrical actuator, electro-mechanical actuator, pneumatic actuator, and hydraulic actuator.
